(19) United States
(12) Patent Application Publication
(10) Pub. No.: US 2019/0314974 A1
(43) Pub. Date: Oct. 17, 2019

(54) ERGONOMIC HAND TOOL

(71) Applicant: GM GLOBAL TECHNOLOGY OPERATIONS LLC, Detroit, MI (US)

(72) Inventors: Jerrod Joseph, Royal Oak, MI (US); Paige Clegg, Rochester Hills, MI (US); Stephen G. Town, Royal Oak, MI (US); Douglas M. Linn, White Lake, MI (US)

(21) Appl. No.: 15/950,279

(22) Filed: Apr. 11, 2018

(51) Int. Cl. B25G 1/10; B25B 31/00

(52) U.S. Cl. CPC B25G 1/102; B25B 31/00

(57) ABSTRACT

An ergonomic hand tool for installing a fuel line clip includes a handle portion having a bottom surface and a proximal end, an intermediate portion obtusely angled from the bottom surface of the handle portion, and a clip retaining portion disposed proximate a distal end of the intermediate portion wherein the clip retaining portion includes a backstop extending in a plane parallel to the bottom surface of the handle portion to a terminal end opposite the proximal end of the handle portion. The backstop extends between two opposing downwardly extending contact surfaces configured to provide a friction fit on a portion of the clip.

### FIELD OF INVENTION

The subject disclosure relates to ergonomic hand tools and more particularly to an ergonomic hand tool for installing redundant fuel line clips.

### BACKGROUND

Without being bound by theory, ergonomic working operations for the human body comprise motions of muscles and joints which are not overstretched or overstressed. Hand tools may be designed for use that does not overstretch or overstress muscles and joints. An ergonomic hand tool is adapted and shaped for muscles and joints to operate in their middle position, the so-called neutral position. For muscles, the middle position provides the optimum opportunity to develop power without being overstretched. For joints, the middle position provides the largest thickness of the joint cartilage whereby optimum protection of the joint is achieved. If a joint is frequently brought into its extreme positions in which a force or power is applied, the joint is stretched in a position where it is most vulnerable. The joint cartilage is thin, and it is eventually worn down. Degenerative arthritis can be developed. The cartilage degenerates and loses its elastic properties.

Moreover, repeated stretching in extreme positions can develop less elastic ligaments that links two bones together at a joint so that the ligaments no longer provides a protective tissue for an otherwise stable joint. Consequently, ergonomic hand tools are designed to avoid or reduce stretching of joints in extreme positions.

### SUMMARY

One or more exemplary embodiments described herein provide an ergonomic hand tool for installing a redundant fuel line clip. In accordance with aspects of one exemplary embodiment, the ergonomic hand tool for installing a redundant fuel line clip includes a handle portion having a bottom surface and a proximal end. Another aspect includes an intermediate portion obtusely angled from the bottom surface of the handle portion. And another aspect includes a clip retaining portion disposed proximate a distal end of the intermediate portion wherein the clip retaining portion includes a backstop extending in a plane parallel to the bottom surface of the handle portion to a terminal end opposite the proximal end of the handle portion wherein the backstop extends between two opposing downwardly extending contact surfaces configured to provide a friction fit on a portion of the clip.

A further aspect in accordance with an exemplary embodiment includes a magnet disposed on the backstop operative to provide a magnetic hold on the clip. Yet another aspect includes a position stabilizing feature configured to engage a complementary position stabilizing feature disposed on the clip. And still another aspect includes an installation feedback system configured to detect, validate, and track installation of at least one clip on a vehicle.

The exemplary embodiment presents other aspects wherein the installation feedback system includes a force sensor or a vibration sensor for detecting, validating and tracking installation of at least one clip on a vehicle. And other aspects are presented wherein the installation feedback system is a wired or a wireless system.

### BRIEF DESCRIPTION OF THE DRAWINGS

The disclosed examples will hereinafter be described in conjunction with the following drawing figures, wherein like numerals denote like elements, and wherein:

FIG. 1 is an illustration of a perspective side view of an ergonomic hand tool for installing a fuel line clip in accordance with aspects of an exemplary embodiment;

FIG. 2A is an illustration of a perspective view of a fuel line clip for installation using the ergonomic hand tool in accordance with aspects of the exemplary embodiment;

FIG. 2B illustrates details of the clip retaining portion of the ergonomic hand tool in accordance with aspects of the exemplary embodiment;

FIG. 2C is an illustration of a fuel line clip being retained on the ergonomic hand tool in accordance with aspects of the exemplary embodiment;

FIG. 3A is an illustration of the method of installation used before development of the ergonomic hand tool; and

FIG. 3B is an illustration of the method of installation after development of the ergonomic hand tool.

### DETAILED DESCRIPTION

An exemplary embodiment is described herein of an ergonomic hand tool for installing a fuel line clip. An ergonomic hand tool is adapted and shaped for muscles and joints to operate in their middle position, the so-called neutral position, to prevent overstretching or overstressing.

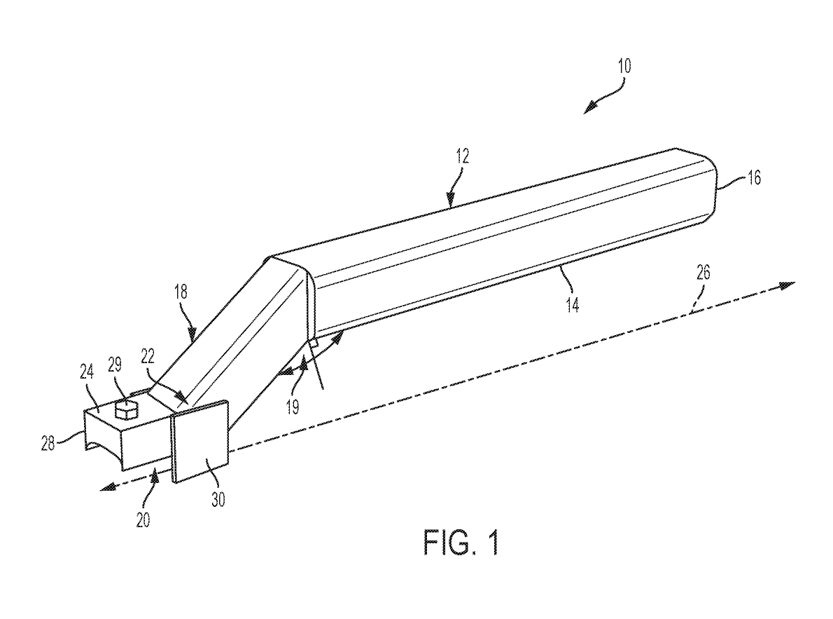

FIG. 1 is an illustration of a perspective side view of an ergonomic hand tool 10 for installing a fuel line clip in accordance with aspects of an exemplary embodiment. The ergonomic hand tool 10 may be formed of molded plastic, metal, and/or composite materials suitable for the intended purpose. The ergonomic hand tool 10 for installing a redundant fuel line clip includes a handle portion 12 having a bottom surface 14 and a proximal end 16. The handle portion 12 is ergonomically designed for ease of use and to prevent overstretching/overstressing of muscles and joints in the hands or fingers such that existing ergonomic standards are satisfied. The handle portion 12 may be disposed with foam rubber or other padding material (not shown) that will make grasping the handle portion 12 more comfortable.

The ergonomic hand tool 12 includes an intermediate portion 18 obtusely angled 19 from the bottom surface 14 of the handle portion 12 in a lever design to provide for a mechanical advantage during installation of a fuel line clip in accordance with aspects of the exemplary embodiment. A clip retaining portion 20 is disposed proximate a distal end 22 of the intermediate portion 18 wherein the clip retaining portion 20 includes a backstop 24 extending in a plane 26 parallel to the bottom surface 14 of the handle portion 12. The backstop 24 extends outward to a terminal end 28 opposite the proximal end 16 of the handle portion 12, and wherein the backstop 24 extends between two opposing downwardly extending contact surfaces 30 configured to provide a friction fit on a portion of the fuel line clip.

The ergonomic hand tool 10 also includes an installation feedback system (not shown) configured to detect, validate, and track installation of at least one clip on a vehicle. The installation feedback system includes at least one sensor 29 disposed on the ergonomic hand tool 10 that communicates with instrumentation (not shown) that receives its output signal to determine if the clip has been correctly installed or not. The instrumentation is also configured to track the each attempted clip installation per vehicle to ensure that improper installations are corrected by the operator. The sensor 29 may be a force type or vibration type sensor such as a piezoelectric or other sensor suitable for the intended purpose and the sensor 29 may communicate with the instrumentation through a wired or wireless connection.

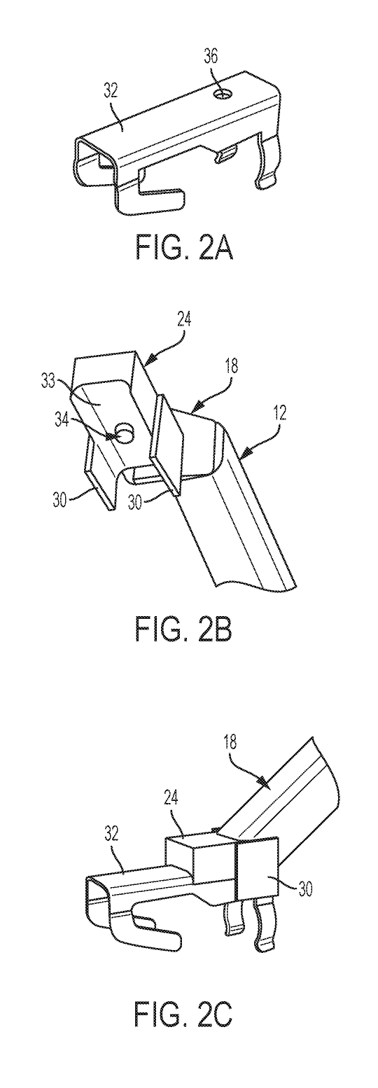

FIGS. 2A-2C illustrate details included on the ergonomic hand tool 10 for holding and restricting movement of the fuel clip in accordance with aspects of the exemplary embodiment. FIG. 2A illustrates a fuel line clip 32 that includes at least one complementary position stabilizing feature 36 configured to engage at least complementary position stabilizing feature 34 disposed on the clip retaining portion 20 of the ergonomic hand tool 10 (See FIG. 2B). The complementary position stabilizing features (34, 36) on the clip retaining portion 20 and the clip 32, respectively, cooperate to prevent fore and aft movement of the clip during installation. Preferably, the clip retaining portion 20 also includes a magnet (not shown) disposed on the clip contacting bottom surface 33 of the backstop 24 that is operative to provide a magnetic hold or retention force on the clip 32. The two opposing downwardly extending contact surfaces 30 are configured to provide a friction fit on a portion of the clip 32 such that the clip 32 can be pressed onto the backstop 24 of the clip retaining portion 20 and adequately retained on the ergonomic hand tool 10 until installed on the fuel line (See FIG. 2C).

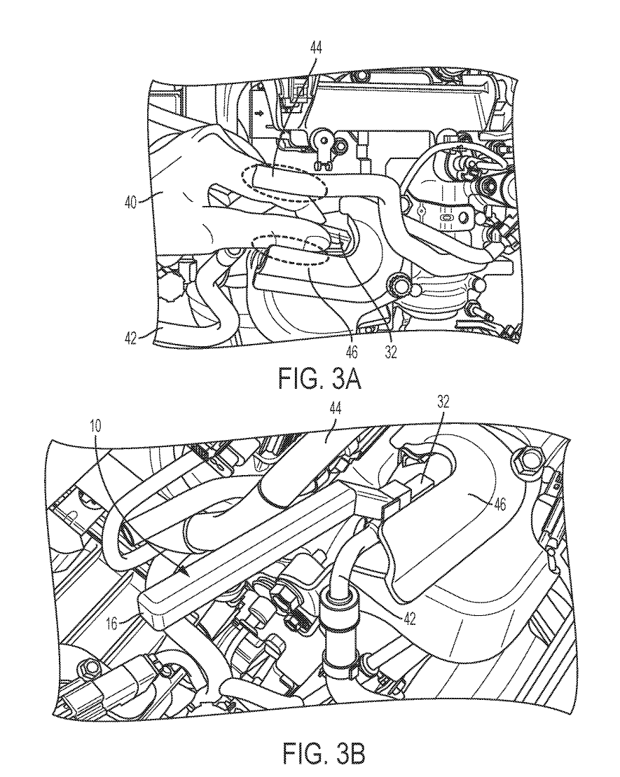

Referring now to FIGS. 3A & 3B, illustrations of the method of installation of the fuel line clip 32 before and after the development of the ergonomic hand tool 10 are provided. FIG. 3A illustrates a fuel line clip 32 being installed with an operator's hand 40 onto a fuel line 42 that is surrounded by obstructions (44, 46). In this case, the operator's hand and fingers may be overstretched or overstressed which could result in improper installation of the clip 32 and/or injury to the operator after several installations due the assembly process not being ergonomically sufficient. FIG. 3B illustrates the fuel line clip 32 being installed with the ergonomic hand tool 10 as according to the exemplary embodiment. Despite the obstructions 44 and 46, the fuel line clip 32 can be easily installed onto the fuel line 42 by the operator without consequence of overstressing the hand or fingers such that ergonomic standards are met.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. An ergonomic hand tool for installing a fuel line clip comprising:
a handle portion having a bottom surface and a proximal end;
an intermediate portion obtusely angled from the bottom surface of the handle portion; and
a clip retaining portion disposed proximate a distal end of the intermediate portion wherein the clip retaining portion includes a backstop extending in a plane parallel to the bottom surface of the handle portion to a terminal end opposite the proximal end of the handle portion wherein the backstop extends between two opposing downwardly extending contact surfaces configured to provide a friction fit on a portion of the clip.

2. The method of claim 1 further comprising a magnet disposed on the backstop operative to provide a magnetic hold on the clip.

3. The hand tool of claim 1 further comprising a position stabilizing feature configured to engage a complementary position stabilizing feature disposed on the clip.

4. The hand tool of claim 1 further comprising an installation feedback system configured to detect, validate, and track installation of at least one clip on a vehicle.

5. The hand tool of claim 4 wherein the installation feedback system comprises a force sensor.

6. The hand tool of claim 4 wherein the installation feedback system comprises a vibration sensor.

7. The hand tool of claim 4 wherein the installation feedback system is a wireless system.

8. The hand tool of claim 4 wherein the installation feedback system is a wired system.

9. An ergonomic hand tool for installing a fuel line clip comprising:
a handle portion having a bottom surface and a proximal end;
an intermediate portion obtusely angled from the bottom surface of the handle portion; and
a clip retaining portion disposed proximate a distal end of the intermediate portion wherein the clip retaining portion includes a backstop extending in a plane parallel to the bottom surface of the handle portion to a terminal end opposite the proximal end of the handle portion wherein the backstop includes a magnet operative to provide a magnetic hold on the clip, and the backstop extends between two opposing downwardly projecting contact surfaces configured to provide a friction fit on a portion of the clip.

10. The hand tool of claim 9 further comprising a position stabilizing feature configured to engage a complementary position stabilizing feature disposed on the clip.

11. The hand tool of claim 9 further comprising an installation feedback system configured to detect, validate, and track installation of at least one clip on a vehicle.

12. The hand tool of claim 11 wherein the installation feedback system comprises a force sensor.

13. The hand tool of claim 11 wherein the installation feedback system comprises a vibration sensor.

14. The hand tool of claim 11 wherein the installation feedback system is a wireless system.

15. The hand tool of claim 11 wherein the installation feedback system is a wired system.
